(19) United States
(12) Patent Application Publication
(10) Pub. No.: US 2022/0131457 A1
(43) Pub. Date: Apr. 28, 2022

(54) POWER CONTROL SYSTEM OF ADAPTIVE CONTROL OF TURN ON TIME

(71) Applicant: INNO-TECH CO., LTD., Taipei City (TW)

(72) Inventors: Shu-Chia Lin, Taipei City (TW); Tsu-Huai Chan, Taipei City (TW); Chih-Feng Lin, Taipei City (TW)

(21) Appl. No.: 17/105,786

(22) Filed: Nov. 27, 2020

(30) Foreign Application Priority Data
Oct. 28, 2020 (TW) 109137475

(51) Int. Cl. H02M 1/36; H02M 7/217

(52) U.S. Cl. CPC H02M 1/36; H02M 2001/0009; H02M 7/217

(57) ABSTRACT

Disclosed is a power control system of adaptive control of turn on time, including a primary side digital controller, a secondary side synchronization controller, a rectification unit, a power unit, a transformer unit, a primary side switch unit, a current sensing unit, a secondary side switch unit, and a secondary side output capacitor for implementing a function of flyback power conversion. The secondary side synchronization controller is intended to turn on or off the secondary side switch unit to achieve a synchronization function of rectification, and the primary side digital controller reduces a primary side drain-source voltage of the primary side switch unit and a secondary side drain-source voltage of the secondary side switch unit by reducing a current sensing limit used to compare with the current sensing signal. The power control system thus greatly improves stability and endurance of the overall operation.

### CROSS-REFERENCE TO RELATED APPLICATION

This application claims the priority of Taiwanese patent application No. 109137475, filed on Oct. 28, 2020, which is incorporated herewith by reference.

### BACKGROUND OF THE INVENTION

### 1. Field of the Invention

The present invention generally relates to a power control system for implementing a function of flyback power conversion, and more specifically to a power control system of adaptive control of turn on time comprising a primary side digital controller, a rectification unit, a power unit, a transformer unit, and a primary side switch unit, a current sensing unit at the primary side, and further comprising a secondary side synchronization controller, a secondary side switch unit, and a secondary side output capacitor at the secondary side, the secondary side synchronization controller turning on or off the secondary side switch unit to achieve a synchronization function, the primary side digital controller reducing a primary side drain-source voltage of the primary side switch unit and a secondary side drain-source voltage of the secondary side switch unit by reducing a current sensing limit used to compare with the current sensing signal, thereby greatly improving stability and endurance of the overall operation.

### 2. The Prior Arts

Since various electric or electronic devices need high quality power to operate, specific power supplies built with high efficiency power converters are required to generate appropriate voltage levels as desired. For example, integrated circuits usually operate at 1.2V, electric motors feeds 12V, and inverters of the backlight module require more than 100V. Most power supplies in the prior arts are commonly implemented by switching power supplies employing the scheme of pulse width modulation (PWM) because of smaller physical size and higher efficiency of conversion than traditional linear power supplies for the same output power.

For a flyback power converter as an example of the switching power supply, a power controller in collocation with a transformer formed of a primary side winding and a secondary side winding, a switch unit, a current sensing resistor, an output rectifier, and an output capacitor is employed to generate the PWM driving signal with a high PWM frequency. The primary side winding of the transformer, the switch unit, and the current sensing resistor configure a primary side loop, and the secondary side winding of the transformer, the output rectifier, and the output capacitor configure a secondary side loop. In particular, the PWM driving signal is received by the switch unit such as a power transistor in the primary side loop to periodically turn on and off the switch unit to further conduct and cut off the current flowing through the switch unit such that the secondary side winding generates a secondary side current through electromagnetic induction with the primary side current flowing through the primary side winding. Then, the secondary side current is processed by the output rectifier and the output capacitor to generate and supply a stable output power to a load for operation.

Furthermore, the output rectifier in the secondary side loop can be implemented by a rectification diode in collocation with the output capacitor, or alternatively, an secondary side switch unit and a secondary side controller in collocation with the output capacitor are employed to achieve the rectification function. In particular, the secondary side controller may even implement a synchronous rectification.

Since the switch unit in the primary side loop usually generates unwantedly spike noise with a considerably high voltage at the drain during a pretty short period of time when turned off by the power controller, voltage stress or transistor stress thus occurs, and as a result, the switch unit is possibly caused to malfunction or even fail due to serious and unrecoverable damage. To overcome the problem, a snubber like a capacitor with large capacitance is widely employed in the prior arts to reduce and suppress voltage stress. Accordingly, for the flyback converter built with the secondary side controller to achieve the synchronous rectification, the secondary side switch unit also needs an additional snubber to reduce voltage tress when turned off by the secondary side controller. However, the snubber requires tough and extreme quality to bear the ultra-high spike such that overall material cost dramatically increases, and a large area of the circuit board is occupied. Consequently, the physical size of the final product provided with the power converter fail to further shrink.

Moreover, the traditional scheme to implement the function of synchronous rectification usually encounters severe risk when the two switch units of the primary and secondary side loops are turned on at the same time for some unwanted and unexpected reasons such that the controller provided in the secondary side loop is carefully and specifically selected. As a result, actual applications are limited.

Therefore, it is greatly needed to provide a new power control system of adaptive control of turn on time comprising a primary side digital controller, a rectification unit, a power unit, a transformer unit, and a primary side switch unit, a current sensing unit at the primary side, and further comprising a secondary side synchronization controller, a secondary side switch unit, and a secondary side output capacitor at the secondary side, the secondary side synchronization controller turning on or off the secondary side switch unit to achieve a synchronization function, the primary side digital controller reducing a primary side drain-source voltage of the primary side switch unit and a secondary side drain-source voltage of the secondary side switch unit by reducing a current sensing limit used to compare with the current sensing signal, thereby greatly improving stability and endurance of the overall operation and overcoming the above problems in the prior arts.

### SUMMARY OF THE INVENTION

The primary object of the present invention is to provide a power control system of adaptive control of turn on time comprising a primary side digital controller, a secondary side synchronization controller, a rectification unit, a power unit, a transformer unit, a primary side switch unit, a current sensing unit, a secondary side switch unit, and a secondary side output capacitor for implementing a function of flyback power conversion.

Specifically, the primary side digital controller comprises a primary side power pin, a primary side ground pin, a primary side driving pin, and a current sensing pin, the secondary side synchronization controller comprises a secondary side driving pin, a secondary side power pin, and a secondary side ground pin, and the transformer unit comprises a primary side winding and a secondary side winding electromagnetically coupled together.

In addition, the primary side switch unit and the secondary side switch unit comprise a Metal-Oxide-Semiconductor (MOS) transistor, a Gallium Nitride field effect transistor (GaN FET), or a silicon carbide (SiC)-MOSFET. Thus, each of the primary side switch unit and the secondary side switch unit has a drain, a gate, and a source.

The above primary side ground pin is electrically connected to a primary side ground level, the secondary side ground pin is electrically connected to a secondary side ground level, and the primary side ground level and the secondary side ground level are the same or different.

The rectification unit receives and rectifies an external input power to generate a rectified power, and the power unit receives the external input power to generate a power voltage served as a secondary side power voltage. The primary side digital controller receives the power voltage through the primary side power pin to operate, and the secondary side synchronization controller receives the secondary side power voltage through the secondary side power pin to operate. Also, an end of the primary side winding is connected to the rectification unit for receiving the rectified power.

Further, an end of the current sensing unit is connected to the current sensing pin, the other end of the current sensing unit is connected to the primary side ground level, and the current sensing pin generates and transmits a current sensing signal to the primary side digital controller through the current sensing pin.

The drain of the primary side switch unit is connected to the other end of the primary side winding, the gate of the primary side switch unit is connected to the primary side driving pin, and the source of the primary side switch unit is connected to the current sensing pin. Also, the drain of the secondary side switch unit is connected to an end of the secondary side winding, the other end of the secondary side winding is connected to the secondary side ground level, and the gate of the secondary side switch unit is connected to the secondary side driving pin.

More specifically, an end of the secondary side output capacitor and an end of a load are connected to the source of the secondary side switch unit, the other end of the secondary side output capacitor and the other end of the load are connected to the secondary side ground level, and the source of the secondary side switch unit generates an output power to supply the load.

In particular, the primary side digital controller generates a primary side driving signal based on the current sensing signal, and further transmits the primary side driving signal to the gate of the primary side switch unit. The primary side driving signal is substantially a pulse width modulation (PWM) signal having a PWM frequency and provided with a turn on level and a turn off level for periodically turning on and off the primary side switch unit to shift a primary side current.

The above secondary side winding generates a secondary side current through electromagnetic induction with the primary side winding, and the secondary side current flows through the secondary side switch unit, the secondary side capacitor, and the load under control of the secondary side synchronization controller.

Further, the primary side digital controller reduces a primary side drain-source voltage across the drain and the source of the primary side switch unit and a secondary side drain-source voltage across the drain and the source of the secondary side switch unit by reducing a current sensing limit corresponding to the current sensing signal. In other words, the so-called transistor stress or voltage stress for the primary side switch unit and the secondary side switch unit is thus effectively reduced. Specifically, the current sensing limit is a comparison value intended to determine whether to turn on the primary side switch unit or not. Accordingly, the primary side switch unit is turned on when the current sensing signal is equal to or greater than the current sensing limit.

Additionally, the secondary side synchronization controller generates a secondary side driving signal based on the secondary side current or the secondary side drain-source voltage of the secondary side switch unit, and the secondary side driving signal is transmitted to the gate of the secondary side switch unit through the secondary side driving pin for turning on or off the secondary side switch unit.

Overall, the present invention specifically employs the secondary side synchronization controller, the secondary side switch unit, and the secondary side output capacitor at the secondary side, and the secondary side synchronization controller is intended to turn on or off the secondary side switch unit to achieve the synchronization function. The primary side digital controller particularly reduces the primary side drain-source voltage and the secondary side drain-source voltage by reducing the current sensing limit to greatly improve stability and endurance of the overall operation.

Another object of the present invention is to provide a power control system of adaptive control of turn on time comprising a primary side digital controller, a secondary side rectification diode, a rectification unit, a power unit, a transformer unit, a primary side switch unit, a current sensing unit, and a secondary side output capacitor for implementing a function of flyback power conversion.

Specifically, the primary side digital controller comprises a primary side power pin, a primary side ground pin, a primary side driving pin, and a current sensing pin, and the primary side ground pin is connected to a primary side ground level. The rectification unit receives and rectifies an external input power to generate a rectified power, and the power unit receives the external input power to generate a power voltage. The primary side digital controller receives the power voltage to operate through the primary side power pin.

Further, the transformer unit comprises a primary side winding and a secondary side winding electromagnetically coupled together, and the primary side switch unit comprises a drain, a gate, and a source. An end of the primary side winding is connected to the rectification unit for receiving the rectified power, the drain of the primary side switch unit is connected to the other end of the primary side winding, and the gate of the primary side switch unit is connected to the primary side driving pin.

Also, an end of the current sensing unit is connected to the current sensing pin and the source of primary side switch unit, and the other end of the current sensing unit is connected to the primary side ground level. The current sensing pin generates and transmits a current sensing signal to the primary side digital controller through the current sensing pin.

The above secondary side rectification diode has a positive end and a negative end. The positive end is connected to an end of the secondary side winding, and the negative end of the secondary side rectification diode is connected to an end of the secondary side output capacitor and an end of a load. The other end of the secondary side winding, the other end of the secondary side output capacitor, and the other end of the load are connected to a secondary side ground level. Specifically, the negative end of the secondary side rectification diode generates an output power to supply the load.

Accordingly, the primary side digital controller generates a primary side driving signal based on the current sensing signal, and further transmits the primary side driving signal to the gate of the primary side switch unit. The primary side driving signal is a pulse width modulation (PWM) signal having a PWM frequency and provided with a turn on level and a turn off level for periodically turning on and off the primary side switch unit to shift a primary side current.

In addition, the secondary side winding generates a secondary side current through electromagnetic induction with the primary side winding, and the secondary side current flows through the secondary side rectification diode to the secondary side output capacitor. The load. The primary side digital controller reduces a primary side drain-source voltage across the drain and the source of the primary side switch unit by reducing a current sensing limit corresponding to the current sensing signal.

More specifically, the current sensing limit is a comparison value intended to determine whether to turn on the primary side switch unit or not, and the primary side switch unit is turned on when the current sensing signal is equal to or greater than the current sensing limit.

Therefore, the secondary side winding, the secondary side rectification diode, and the secondary side output capacitor are employed to form a secondary side loop for collocating with a primary side loop formed of the primary side winding, the primary side switch unit, and the current sensing unit controlled by the primary side digital controller, and the primary side digital controller reduces a primary side drain-source voltage of the primary side switch unit and a secondary side drain-source voltage of the secondary side switch unit by particularly reducing a current sensing limit used to compare with the current sensing signal, thereby greatly improving stability and endurance of the overall operation.

### BRIEF DESCRIPTION OF THE DRAWINGS

The present invention can be understood in more detail by reading the subsequent detailed description in conjunction with the examples and references made to the accompanying drawings, wherein:

FIG. 1 is a view showing the power control system of adaptive control of turn on time according to the first embodiment of the present invention;

FIG. 2 is a view showing the operation waveform of the power control system according to the first embodiment of the present invention; and

FIG. 3 is a view showing the power control system of adaptive control of turn on time according to the second embodiment of the present invention.

### DETAILED DESCRIPTION OF THE PREFERRED EMBODIMENT

The present invention may be embodied in various forms and the details of the preferred embodiments of the present invention will be described in the subsequent content with reference to the accompanying drawings. The drawings (not to scale) show and depict only the preferred embodiments of the invention and shall not be considered as limitations to the scope of the present invention. Modifications of the shape of the present invention shall too be considered to be within the spirit of the present invention.

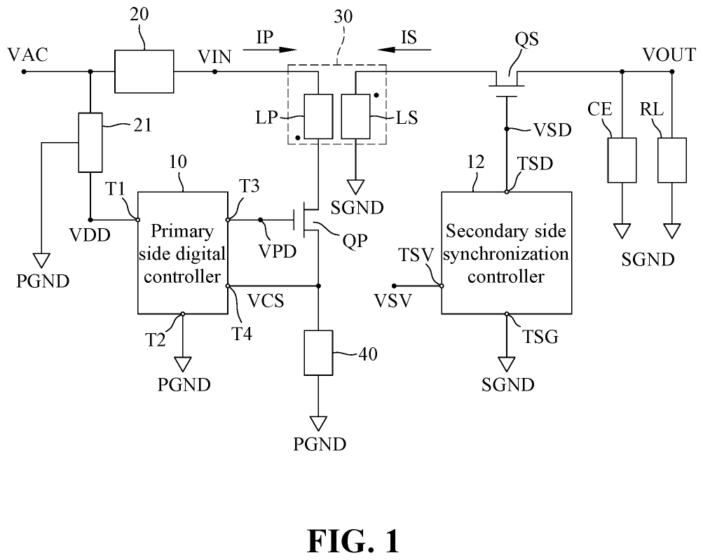

Please refer to FIG. 1 illustrating the power control system of adaptive control of turn on time according to the first embodiment of the present invention. As shown in FIG. 1, the power control system of adaptive control of turn on time according to the first embodiment of the present invention comprises a primary side digital controller 10, a secondary side synchronization controller 12, a rectification unit 20, a power unit 21, a transformer unit 30, a primary side switch unit QP, a current sensing unit 40, a secondary side switch unit QS, and a secondary side output capacitor CE for implementing a function of flyback power conversion.

Specifically, the primary side digital controller 10 generally comprises a primary side power pin T1, a primary side ground pin T2, a primary side driving pin T3, and a current sensing pin T4, the secondary side synchronization controller 12 comprises a secondary side driving pin TSD, a secondary side power pin TSV, and a secondary side ground pin TSG, and the transformer unit 30 comprises a primary side winding LP and a secondary side winding LS electromagnetically coupled together. In addition, each of the primary side switch unit QP and the secondary side switch unit QS comprises a Metal-Oxide-Semiconductor (MOS) transistor, a Gallium Nitride field effect transistor (GaN FET), or a silicon carbide (SiC)-MOSFET, and thus has a drain, a gate, and a source.

Further, the rectification unit 20 receives and rectifies an external input power VAC to generate a rectified power VIN, and the power unit 21 receives the external input power VAC to generate a power voltage VDD. The primary side digital controller 10 receives the power voltage VDD through the primary side power pin T1 to operate, and the secondary side synchronization controller 12 receives the secondary side power voltage VSV through the secondary side power pin TSV to operate. For example, the secondary side power voltage VSV is the power voltage VDD, or alternatively, a secondary side power unit (not shown) like the power unit 21 is additionally provided to receive the external input power VAC to generate and supply power as desired for the secondary side synchronization controller 12 to operate. Since the power unit 21 and the secondary side power unit are commonly used in the prior arts, the detailed description is thus omitted hereinafter.

Further, the primary side ground pin T2 of the primary side digital controller 10 is connected to a primary side ground level PGND, and the secondary side ground pin TSG of the secondary side synchronization controller 12 is connected to a secondary side ground level SGND. In particular, the primary side ground level PGND and the secondary side ground level SGND are the same or different depending on actual applications.

Also, an end of the primary side winding LP is connected to the rectification unit 20 for receiving the rectified power VIN, the drain of the primary side switch unit QP is connected to the other end of the primary side winding LP, the gate of the primary side switch unit QP is connected to the primary side driving pin T3, and the source of the primary side switch unit QP is connected to the current sensing pin T4. Also, an end of the current sensing unit 40 is connected to the current sensing pin T4, the other end of the current sensing unit 40 is connected to the primary side ground level PGND, and the current sensing pin 40 generates and transmits a current sensing signal VCS to the primary side digital controller 10 through the current sensing pin T4.

Further, the primary side digital controller 10 generates a primary side driving signal VPD based on the current sensing signal VCS through the current sensing pin T4, and further transmits the primary side driving signal VPD to the gate of the primary side switch unit QP through the primary side driving pin T3 for controlling the primary side switch unit QP to turn on or off for implementing switching power control. Thus, a primary side current IP flowing through the primary side winding LP is adapted and shifted. More specifically, the primary side driving signal VPD is substantially a pulse width modulation (PWM) signal having a PWM frequency and provided with a turn on level and a turn off level for periodically turning on and off the primary side switch unit QP to shift the primary side current IP.

In the secondary side, an end of the secondary side winding LS is connected to the drain of the secondary side switch unit QS, the other end of the secondary side winding LS is connected to the secondary side ground level SGND, and the gate of the secondary side switch unit QS is connected to the secondary side driving pin TSD. In addition, an end of the secondary side output capacitor CE and an end of a load RL are connected to the source of the secondary side switch unit QS, the other end of the secondary side output capacitor CE and the other end of the load RL are connected to the secondary side ground level SGND, and the source of the secondary side switch unit QS generates an output power VOUT to supply the load RL.

Moreover, the secondary side winding LS generates a secondary side current IS through electromagnetic induction with the primary side winding LP, and the secondary side current IS then flows through the secondary side switch unit QS, the secondary side capacitor CE, and the load RL under control of the secondary side synchronization controller 12. Particularly, the secondary side capacitor CE and the load RL connected in parallel are further serially connected to the secondary side switch unit QS.

Overall, the rectification unit 20, the primary side winding LP of the transformer 30, the primary side switch unit QP, and the current sensing unit 40 configure a primary side loop, and the primary side digital controller 10 controls the primary side switch unit QP to turn on or off for controlling the conduction current flowing through the primary side loop. On the other hand, the secondary side winding LS of the transformer 30, the secondary side switch unit QS, and the secondary side output capacitor CE form a secondary side loop, and the secondary side digital controller 12 controls the secondary side switch unit QS to turn on or off for controlling the conduction current flowing through the secondary side loop, thereby implementing the function of synchronous rectification. Further, the secondary side output capacitor CE is collocated to generate the stable output power VOUT to supply the load RL.

In other words, the primary side digital controller 10 controls the current of the primary side loop, and the transformer 30 generates the current of the secondary side loop through electromagnetic induction such that the secondary side digital controller 12 further controls the current of the secondary side loop to collocate with the primary side digital controller 10.

More specifically, the secondary side digital controller 12 generates the secondary side driving signal VSD based on the secondary side current IS or the primary side drain-source voltage of the secondary side switch unit QS, and the secondary side driving signal VSD is transmitted to the gate of the secondary side switch unit QS through the secondary side driving pin TSD for controlling the secondary side switch unit QS to turn on or off. For example, when the secondary side current IS is negative, that is, the secondary side current IS flows to the secondary side winding LS from the secondary side switch unit QS, or when the secondary side drain-source voltage of the secondary side switch unit QS is positive, the secondary side synchronization controller 12 turns on the secondary side switch unit QS through the secondary side driving signal VSD, and when the secondary side current IS is positive, that is, the secondary side current IS flows to the secondary side switch unit QS from the secondary side winding LS, or when the secondary side drain-source voltage of the secondary side switch unit QS is negative, the secondary side synchronization controller 12 turns off the secondary side switch unit QS through the secondary side driving signal VSD.

To further reduce voltage drop from the secondary side winding LS to the load RL resulting from the turn on resistance of the secondary side switch units QS, it is feasible to connect a plurality of the secondary side switch units QS to form a big switch unit with lower effective turn on resistance driven by the secondary side driving signal VSD at the same time.

It should be noted that the scheme mentioned above for the secondary side synchronization controller 12 to detect the secondary side current IS and the drain-source voltage of the secondary side switch unit QS is commonly used in the prior arts, like employing a comparator in collocation with an additional pin, and the detailed description is thus omitted hereinafter.

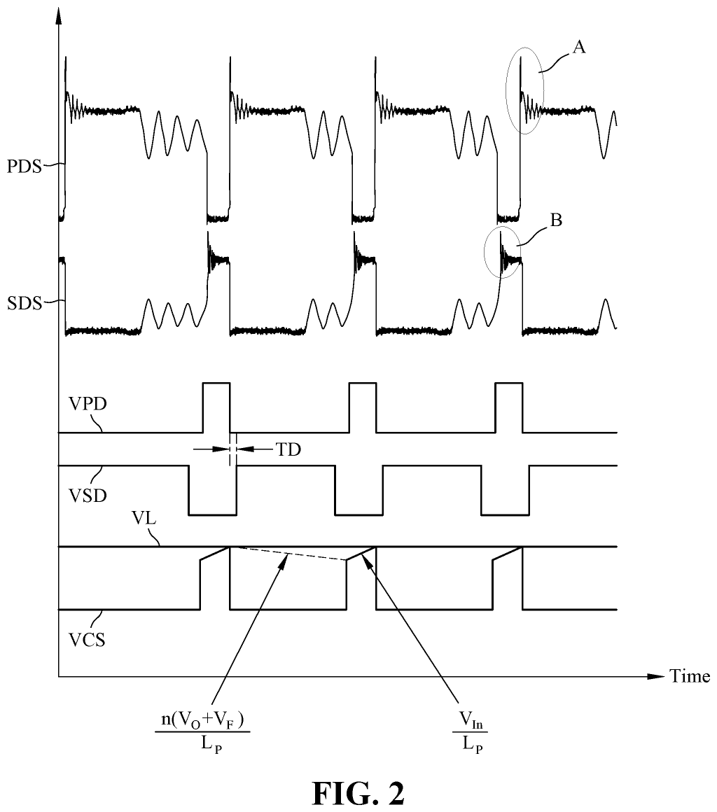

Further refer to FIG. 2 illustrating the operation waveform of the power control system according to the first embodiment of the present invention, including the primary side driving signal VPD, the secondary side driving signal VSD, the primary side drain-source voltage PDS of the primary side switch unit QP, and the secondary side drain-source voltage SDS of the secondary side switch unit QS.

In the exemplary embodiment, the primary side switch unit QP is a n-channel metal oxide semiconductor (NMOS), and the secondary side switch unit QS is a p-channel metal oxide semiconductor (PMOS). Thus, the primary side switch unit QP is turned on when the primary side drain-source voltage PDS is a high level, and the secondary side switch unit QS is turned on when the secondary side drain-source voltage SDS is a low level. Of course, the primary side switch unit QP and the secondary side switch unit QS can be implemented by other transistors for the primary side drain-source voltage PDS and the secondary side drain-source voltage SDS with corresponding voltage levels to turn on, respectively. All the schemes to turn on the primary side switch unit QP and the secondary side switch unit QS are included in the scope of the present invention.

It should be also noted that the region A of the primary side drain-source voltage PDS and the region B of the secondary side drain-source voltage SDS in FIG. 2 respectively indicate MOS tress with spike noise suffered by the primary side switch unit QP and the secondary side switch unit QS while turned off.

More specifically, to reduce transistor stress of the primary side switch unit QP and the secondary side switch unit QS, the primary side digital controller 10 of the present invention appropriately and flexibly reduces a current sensing limit VL corresponding to the current sensing signal VCS, and the current sensing limit VL is a comparison value intended to determine whether to turn on the primary side switch unit QP or not. Specifically, the primary side switch unit QP is turned on only when the current sensing signal VCS is equal to or greater than the current sensing limit VL. Overall, as the current sensing limit VL is smaller, transistor stress suffered by the primary side switch unit QP and the secondary side switch unit QS is greatly reduced and suppressed.

In addition, the primary side digital controller 10 may further reduce transistor stress of the secondary side switch unit QS by adapting a driving strength of the primary side switch unit QP, entering a quasi-resonance (QR) mode, or slowing down the PWM frequency of the primary side driving signal VPD.

As for adapting the driving strength of the primary side switch unit QP, one of the schemes is to dynamically adapt the turn on level of the primary side driving signal VPD to turn on the primary side switch unit QP. In other words, as the turn on level becomes higher, the driving strength increases, and transistor stress of the primary side switch unit QP and the secondary side switch unit QS thus increases.

If the primary side digital controller 10 enters the QR mode, that is, the primary side switch unit QP and the secondary side switch unit QS are turned on when the respective drain voltage decreases to a lowest level, thereby reducing switch loss, improving efficiency of power conversion, and at the same time, suppressing transistor stress of the primary side switch unit QP and the secondary side switch unit QS.

When the PWM frequency of the primary side driving signal VPD increases, the primary side switch unit QP and the secondary side switch unit QS suffer transistor stress more frequently, and it is thus effective to appropriately slow down the PWM frequency for suppressing transistor stress of the primary side switch unit QP and the secondary side switch unit QS.

It should be noted that the schemes of adapting the driving strength, entering the QR mode, and slowing down the PWM frequency are quite common in the prior arts, and the detailed description is omitted hereinafter.

Also, the primary side digital controller 10 may further flexibly and appropriately adapt a maximum duty or a minimum off time of the primary side switch unit QP in collocation with a minimum on time of the secondary side synchronization controller 12 to prevent the primary side switch unit QP and the secondary side switch unit QS from simultaneously turning on. In other words, the primary side switch unit QP and the secondary side switch unit QS are constantly separated to turn on by a delay time TD, thereby decreasing reversed voltage at the secondary side, that is, transistor stress of the primary side switch unit QP and the secondary side switch unit QS.

For instance, when the secondary side current is positive, the secondary side synchronization controller 12 waits the delay time TD and then turns on the secondary side switch unit QS. Since the secondary side synchronization controller 12 is substantially formed of intrinsic digital circuits such as a central processing unit (CPU) or a micro controller (MCU) in collocation with peripheral circuits performing specific software or firmware program, the delay time TD is previously stored in a storage medium like memory or a register of the CPU or MCU, and particularly allowed to be readily updated by an external device according to the actual situation. As a result, such as scheme is convenient and flexible for practical application.

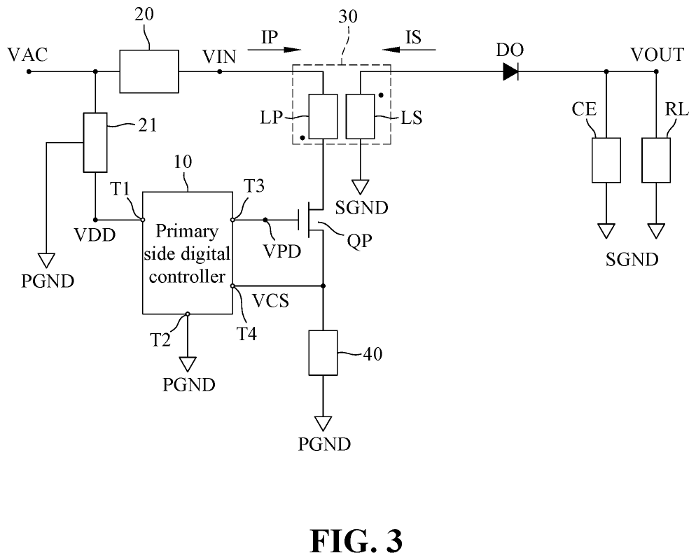

Further refer to FIG. 3 illustrating the power control system of adaptive control of turn on time according to the second embodiment of the present invention. As shown in FIG. 3, the power control system of adaptive control of turn on time according to the second embodiment of the present invention comprises a primary side digital controller 10, a rectification unit 20, a power unit 21, a transformer unit 30, a primary side switch unit QP, a secondary side rectification diode DO, a secondary side output capacitor CE, and a current sensing unit 40 for implementing a function of flyback power conversion.

It should be noted that the power control system of the second embodiment is similar to the power control system of the first embodiment, and the primary difference is that the power control system of the second embodiment employs the secondary side rectification diode DO, to replace the secondary side switch unit QS of the first embodiment, and further removes the secondary side digital controller 12.

Overall, the rectification unit 20, the primary side winding LP of the transformer unit 30, the primary side switch unit QP, and the current sensing unit 40 of the second embodiment configure a primary side loop, and the primary side digital controller 10 controls the primary side switch unit QP to turn on or off so as to adapt a conduction current as a primary side current flowing the primary side loop. It is obvious that the primary side loop has the aspects as the same as the second embodiment, and is thus not described again hereinafter.

On the other hand, the secondary side winding LS of the transformer unit 30, the secondary side rectification diode DO, and the secondary side output capacitor CE of the second embodiment configure a secondary side loop, and the secondary side rectification diode DO rectifies a conduction current as a secondary side current flowing the secondary side loop, and further collocates with the secondary side output capacitor CE to generate a stable output power VOUT supplying a load RL.

In other words, the primary side digital controller 10 controls the primary side current, the transformer 30 generates the secondary current through electromagnetic induction with the primary side current, the secondary side rectification diode DO rectifies the secondary side current for the secondary side output capacitor CE to generate the output power VOUT as desired.

Accordingly, the primary side digital controller 10 receives and employs the current sensing signal VCS through the current sensing pin T4 to generate the primary side driving signal VPD as an intrinsic PWM signal based on the current sensing signal VCS, and further transmits the primary side driving signal VPD to the gate of the primary side switch unit QP through the primary side driving pin T3 for controlling the primary side switch unit QP to turn on or off. Particularly, the primary side digital controller 10 adapts the driving strength of the primary side switch unit QP, enters a quasi-resonance (QR) mode, or slows down the PWM frequency of the primary side driving signal VPD to reduce the primary side drain-source voltage of the primary side switch unit QP.

Since the other elements of the second embodiment are the same as the first embodiment mentioned above, related aspects are not described hereinafter.

It should be noted that in contrast to the first embodiment provided with the secondary side digital controller 12 controlling the secondary side switch unit QS, while the second embodiment employs the secondary side rectification diode DO with 0.7V drop and consuming more power while being turned on, the overall electrical circuit architecture is simpler and peripheral elements are fewer such that the circuit board layout is easy to implement, and the cost is lower. As a result, the second embodiment is still competitive for specific applications.

From the above mention, one aspect of the present invention is that the rectification unit, the primary side winding, the primary side switch unit, the current sensing unit configure the primary side loop, and the secondary side winding, the secondary side rectification diode, and the secondary side output capacitor configure the secondary side loop, the primary side digital controller turns on or off the primary side switch unit to control the primary side current, the secondary side rectification controller turns on or off the secondary side switch unit to control the secondary side current for implementing the function of synchronous rectification, and the secondary side output capacitor in collocation generates the stable output power to supply the load.

Moreover, the primary side digital controller and the secondary side rectification controller are employed to respectively control the primary side switch unit and the secondary side switch unit to avoid turning on at the same time and assure turning on by the delay time, thereby greatly improving safety and stability of electrical operation.

In particular, the primary side digital controller reduces the current sensing limit corresponding to the current sensing signal to reduce transistor stress of the primary side switch unit and the secondary side switch unit, or alternatively, transistor stress is reduced by adapting the driving strength of the primary side switch unit, entering the QR mode, or slowing down the PWM frequency of the primary side driving signal.

In addition, another aspect of the present invention is that the primary side loop is in collocation with the simple secondary side loop formed of only the secondary side winding, the secondary side rectification diode, and the secondary side output capacitor, and the power control function to supply the load the stable output power is also implemented. Further, the primary side digital controller effectively reduces transistor stress of the secondary side switch unit by reducing the current sensing limit, adapting the driving strength of the primary side switch unit, entering the QR mode, or slowing down the PWM frequency of the primary side driving signal, thereby assuring stability of overall operation.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A power control system of adaptive control of turn on time for implementing a function of flyback power conversion, comprising:
a primary side digital controller comprising a primary side power pin, a primary side ground pin, a primary side driving pin, and a current sensing pin, the primary side ground pin electrically connected to a primary side ground level;
a secondary side synchronization controller comprising a secondary side driving pin, a secondary side power pin, and a secondary side ground pin, the secondary side ground pin electrically connected to a secondary side ground level;
a rectification unit for receiving and rectifying an external input power to generate a rectified power;
a power unit for receiving the external input power to generate a power voltage, the primary side digital controller receiving the power voltage through the primary side power pin to operate, the power voltage served as a secondary side power voltage, the secondary side synchronization controller receiving the secondary side power voltage through the secondary side power pin to operate; and
a transformer unit comprising a primary side winding and a secondary side winding electromagnetically coupled together, an end of the primary side winding connected to the rectification unit for receiving the rectified power;
a primary side switch unit comprising a drain connected to the other end of the primary side winding, a gate connected to the primary side driving pin, and a source;
a current sensing unit having an end connected to the current sensing pin and the source of primary side switch unit, and the other end connected to the primary side ground level, the current sensing pin generating and transmitting a current sensing signal to the primary side digital controller through the current sensing pin;
a secondary side switch unit comprising a drain connected to an end of the secondary side winding, a gate connected to the secondary side driving pin, and a source, the other end of the secondary side winding connected to the secondary side ground level; and
a secondary side output capacitor, the source of the secondary side switch unit connected to an end of the secondary side output capacitor and an end of a load, the other end of the secondary side output capacitor and the other end of the load connected to the secondary side ground level, the source of the secondary side switch unit generating an output power to supply the load,
wherein the primary side digital controller generates a primary side driving signal based on the current sensing signal, and further transmits the primary side driving signal to the gate of the primary side switch unit, the primary side driving signal is a pulse width modulation (PWM) signal having a PWM frequency and provided with a turn on level and a turn off level for periodically turning on and off the primary side switch unit to shift a primary side current, the secondary side winding generates a secondary side current through electromagnetic induction with the primary side winding, the secondary side current flows through the secondary side switch unit, the secondary side output capacitor, and the load under control of the secondary side synchronization controller, the primary side digital controller reduces a primary side drain-source voltage across the drain and the source of the primary side switch unit and a secondary side drain-source voltage across the drain and the source of the secondary side switch unit by reducing a current sensing limit corresponding to the current sensing signal, the current sensing limit is a comparison value intended to determine whether to turn on the primary side switch unit or not, the primary side switch unit is turned on when the current sensing signal is equal to or greater than the current sensing limit, the secondary side synchronization controller generates a secondary side driving signal based on the secondary side current or the secondary side drain-source voltage of the secondary side switch unit, and the secondary side driving signal is transmitted to the gate of the secondary side switch unit through the secondary side driving pin.

2. The power control system as claimed in claim 1, wherein the primary side switch unit and the secondary side switch unit comprise a Metal-Oxide-Semiconductor (MOS) transistor, a Gallium Nitride field effect transistor (GaN FET), or a silicon carbide (SiC)-MOSFET.

3. The power control system as claimed in claim 1, wherein the secondary side synchronization controller employs the secondary side driving signal to turn on the primary side switch unit when the secondary side current flows to the secondary side switch unit from the secondary side winding or when the secondary side drain-source voltage of the secondary side switch unit is positive, and the secondary side synchronization controller employs the secondary side driving signal to turn off the primary side switch unit when the secondary side current flows to the secondary side winding from the secondary side switch unit or when the secondary side drain-source voltage of the secondary side switch unit is negative.

4. The power control system as claimed in claim 3, wherein the primary side digital controller further reduces the secondary side drain-source voltage of the secondary side switch unit by adapting a driving strength of the primary side switch unit, entering a quasi-resonance (QR) mode, or slowing down the PWM frequency of the primary side driving signal.

5. The power control system as claimed in claim 1, wherein the primary side digital controller further adapts a maximum duty or a minimum off time of the primary side switch unit in collocation with a minimum on time of the secondary side synchronization controller to prevent the primary side switch unit and the secondary side switch unit from simultaneously turning on, and reduce the primary side drain-source voltage of the primary side switch unit and the secondary side drain-source voltage of the secondary side switch unit.

6. A power control system of adaptive control of turn on time for implementing a function of flyback power conversion, comprising:
a primary side digital controller comprising a primary side power pin, a primary side ground pin, a primary side driving pin, and a current sensing pin, the primary side ground pin electrically connected to a primary side ground level;
a rectification unit for receiving and rectifying an external input power to generate a rectified power;
a power unit for receiving the external input power to generate a power voltage, the primary side digital controller receiving the power voltage to operate through the primary side power pin;
a transformer unit comprising a primary side winding and a secondary side winding electromagnetically coupled together, an end of the primary side winding connected to the rectification unit for receiving the rectified power;
a primary side switch unit comprising a drain connected to the other end of the primary side winding, a gate connected to the primary side driving pin, and a source;
a current sensing unit having an end connected to the current sensing pin and the source of primary side switch unit, and the other end connected to the primary side ground level, the current sensing pin generating and transmitting a current sensing signal to the primary side digital controller through the current sensing pin;
a secondary side rectification diode having a positive end and a negative end, the positive end connected to an end of the secondary side winding; and
a secondary side output capacitor, the negative end of the secondary side rectification diode connected to an end of the secondary side output capacitor and an end of a load, the other end of the secondary side winding, the other end of the secondary side output capacitor, and the other end of the load connected to a secondary side ground level, the negative end of the secondary side rectification diode generating an output power to supply the load,
wherein the primary side digital controller generates a primary side driving signal based on the current sensing signal, and further transmits the primary side driving signal to the gate of the primary side switch unit, the primary side driving signal is a pulse width modulation (PWM) signal having a PWM frequency and provided with a turn on level and a turn off level for periodically turning on and off the primary side switch unit to shift a primary side current, the secondary side winding generates a secondary side current through electromagnetic induction with the primary side winding, the secondary side current flows through the secondary side rectification diode to the secondary side output capacitor, and the load, the primary side digital controller reduces a primary side drain-source voltage across the drain and the source of the primary side switch unit by reducing a current sensing limit corresponding to the current sensing signal, the current sensing limit is a comparison value intended to determine whether to turn on the primary side switch unit or not, and the primary side switch unit is turned on when the current sensing signal is equal to or greater than the current sensing limit.

7. The power control system as claimed in claim 6, wherein the primary side switch unit comprises a Metal-Oxide-Semiconductor (MOS) transistor, a Gallium Nitride field effect transistor (GaN FET), or a silicon carbide (SiC)-MOSFET.

8. The power control system as claimed in claim 6, wherein the primary side digital controller further reduces the primary side drain-source voltage of the primary side switch unit by adapting a driving strength of the primary side switch unit.

9. The power control system as claimed in claim 6, wherein the primary side digital controller further reduces the primary side drain-source voltage of the primary side switch unit by entering a quasi-resonance (QR) mode.

10. The power control system as claimed in claim 6, wherein the primary side digital controller further reduces the primary side drain-source voltage of the primary side switch unit by slowing down the PWM frequency of the primary side driving signal.
